(19) United States
(12) Patent Application Publication
(10) Pub. No.: US 2024/0054611 A1
(43) Pub. Date: Feb. 15, 2024

(54) SYSTEMS AND METHODS FOR ENCODING TEMPORAL INFORMATION FOR VIDEO INSTANCE SEGMENTATION AND OBJECT DETECTION

(71) Applicant: Samsung Electronics Co., Ltd., Suwon-si (KR)

(72) Inventors: Biplab Ch Das, Bengaluru (IN); Kiran Nanjunda Iyer, Bengaluru (IN); Shouvik Das, Bengaluru (IN); Himadri Sekhar Bandyopadhyay, Bengaluru (IN)

(21) Appl. No.: 18/492,234

(22) Filed: Oct. 23, 2023

Related U.S. Application Data
(63) Continuation of application No. PCT/KR2023/006880, filed on May 19, 2023.

(30) Foreign Application Priority Data
May 20, 2022 (IN) 202241029184

(51) Int. Cl. G06T 5/50; G06T 7/10; G06V 10/25; G06V 10/56

(52) U.S. Cl. CPC G06T 5/50; G06T 7/10; G06V 10/25; G06V 10/56; G06T 2207/10024; G06T 2207/20084; G06T 2207/20221

(57) ABSTRACT

In a method of encoding of temporal information for stable video instance segmentation and video object detection, a neural network analyzes an input frame of a video to output a prediction template. The prediction template includes either segmentation masks of objects in the input frame or bounding boxes surrounding objects in the input frame. The prediction template is then colour coded by a template generator. The colour coded template, along with a frame subsequent to the input frame, is supplied to a template encoder such that temporal information from the input frame is encoded into the output of the temporal encoder.

### CROSS REFERENCE TO RELATED APPLICATIONS

This application is a continuation of International Application No. PCT/KR2023/006880, designating the United States, filed May 19, 2023, in the Korean Intellectual Property Receiving Office, and which is based on and claims priority to Indian Patent Application No. 202241029184, filed May 20, 2022, in the Indian Patent Office. The contents of each of these applications are incorporated by reference herein in their entireties.

### BACKGROUND

### Field

The disclosure relates to video instance segmentation and video object detection and, for example, to encoding of temporal information for stable video instance segmentation and video object detection.

### Description of Related Art

Temporal information encoding can be used for various applications such as video segmentation, object detection, action segmentation etc. In such applications, neural network prediction may need to be stabilized, as it may be sensitive to changes in the properties of objects present in the frames of an input video. Examples of such properties are illumination, pose, or position of any such objects in the frames of the input video. Any slight change to the objects can cause a large deviation or error in the output of the neural network, due to which stabilizing the neural network prediction is desirable. Examples of the error in the output can be an incorrect segmentation prediction by the neural network or an incorrect detection of an object in the frames of the input video.

Traditional approaches for stabilizing the neural network involve addition of neural net layers, which can be computationally expensive. In addition to receiving the present frame of the input video, the neural network may also receive one or more previous frames of the input video and the outputted predictions from the neural network. However, this can result in bulky network inputs which can lead to high memory and power consumption.

Other approaches for stabilizing the neural network can involve fixing a target object in a frame of the input video, and only tracking the target object in subsequent frames. However, this approach can make real-time segmentation of multiple objects nearly impossible. It is also desirable that any real-time solutions in electronic devices require as little change as possible in the neural network architecture and the neural network input, while also producing high quality temporal results of segmentation and detection.

FIG. 1 illustrates a problem with segmentation map prediction when temporal information is not incorporated/encoded in the input frame fed to a neural network. In FIG. 1, a first and a second input frame are fed to a segmentation neural network. The first and the second input frame depict an individual with his hand in front of him to gesture a hand-waving motion. The difference between the first and the second input frame is that in the second input frame, there is a slight deviation in the individual's hand compared to the first input frame. When the first input frame is fed to the segmentation neural network, the neural network is able to output a segmentation map that includes an outline of the individual in the first input frame. However, when the second input frame is fed to the segmentation neural network, the outputted segmentation map, in addition to the outline of the individual in the second input frame, includes an outline of the chair behind the individual, which is an incorrect prediction, as the outline of the chair is not supposed to be segmented.

It is therefore desirable to incorporate temporal information, which may be the neural network prediction from a previous input frame, in a subsequent input frame to stabilize the neural network prediction to obtain accurate outputs.

### SUMMARY

Example embodiments disclosed herein can provide systems and methods for encoding temporal information for stable video instance segmentation and video object detection.

Accordingly, example embodiments herein provide methods and systems for intelligent video instance segmentation and object detection. In an example embodiment, a method may include identifying, by a neural network, at least one region indicative of one or more instances in a first frame by analyzing the first frame among a plurality of frames; outputting, by the neural network, a prediction template having the one or more instances in the first frame; generating, by a template generator, a colour coded template of the first frame by applying at least one colour to the prediction template having the one or more instances in the first frame; and generating, by a template encoder, a modified second frame by combining a second frame and the colour coded template of the first frame. For any subsequent frames, the modified second frame may be fed to the neural network and the previous steps may be iteratively performed until all the frames in the plurality of frames are analyzed by the neural network.

In an example embodiment, a method may include receiving, by a neural network, a first frame among a plurality of frames; analyzing, by the neural network, the first frame to identify a region indicate of one or more instances in the first frame; includes generating, by the neural network, a template having the one or more instances in the first frame; applying, by a template generator, at least one colour to the template having the one or more instances in the first frame to generate a colour coded template of the first frame; receiving, by the neural network, a second frame; generating, by the template encoder, a modified second frame by merging the colour coded template of the first frame with the second frame; and supplying the modified second frame to the neural network to segment the one or more instances in the modified second frame.

In an example embodiment, a method may include receiving, by a neural network, an image frame including red-green-blue (RGB) channels; generating, by a template generator, a template having one or more colour coded instances from the image frame; and merging, by the template encoder, the template having the one or more colour coded instances with the RGB channels of image frames subsequent to the image frame, as a preprocessed input for image segmentation in the neural network.

In an example embodiment, a system may include an electronic device, a neural network, a template generator, and a template encoder. The electronic device may include a capturing device for capturing at least one frame. The neural network is configured to perform at least one of the following: i) identifying at least one region indicative of one more instances in a first frame by analyzing the first frame among a plurality of frames from a preview of the capturing device; and ii) outputting a prediction template having the one or more instances in the first frame. The template generator is configured to generate a colour coded template of the first frame by applying at least one colour to the prediction template having the one or more instances in the first frame and to generate a modified second frame by merging a second frame and the colour coded template of the first frame.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the embodiments herein include all such modifications.

### BRIEF DESCRIPTION OF THE DRAWINGS

The above and other aspects, features and advantages of certain embodiments of the present disclosure will be more apparent from the following detailed description taken in conjunction with the accompanying drawings, in which:

FIG. 1 illustrates a problem in the prediction of a segmentation map when temporal information is not incorporated in an input frame to a neural network according to conventional art;

FIG. 2 is a flow diagram for example encoding of temporal information from a previous frame onto a subsequent frame according to various embodiments;

FIG. 3 illustrates an example process for encoding temporal information to perform object/instance segmentation for a single person video sequence according to various embodiments;

FIG. 4 illustrates an example process for encoding temporal information to perform object/instance segmentation for a two person video sequence according to various embodiments;

FIG. 5 illustrates an example process for encoding temporal information to perform object detection for a double person video sequence according to various embodiments;

FIG. 6 illustrates a training phase for an example model for stabilizing a neural network prediction according to various embodiments;

FIGS. 7A and 7B illustrate a comparison between results from an independent frame-based segmentation of a video sequence and a colour-template based temporal information encoded segmentation of a video sequence according to various embodiments;

FIGS. 8A and 8B illustrate a comparison between results from a fourth channel with grayscale segmentation map used for temporal information encoding and a colour template used for temporal information encoding;

FIG. 9 is an example screenshot of object detection performed using temporal information encoding according to various embodiments;

FIGS. 10A and 10B are example screenshots of video instance segmentation performed using temporal information encoding according to various embodiments;

FIG. 11 is an example screenshot of selective instance segmentation performed using temporal information encoding according to various embodiments;

FIG. 12 are example screenshots of creating a motion trail effect using temporal information encoding according to various embodiments;

FIG. 13 are example screenshots of adding filters to instances segmented using temporal information encoding according to various embodiments; and

FIG. 14 is a block diagram of an example electronic device configured to encode temporal information according to various embodiments.

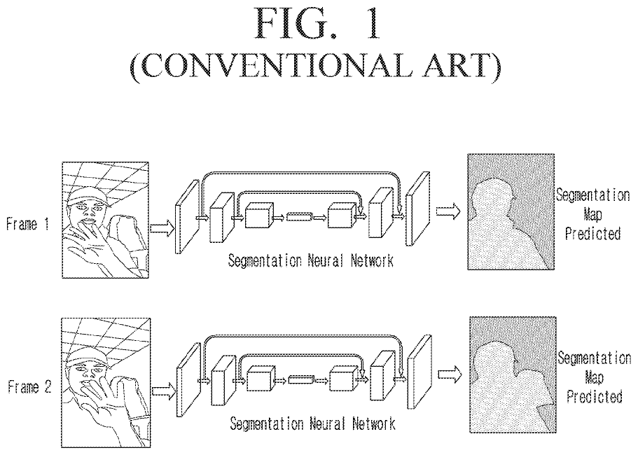

### DETAILED DESCRIPTION

The example embodiments herein and the various features and advantageous details thereof are explained more fully with reference to the non-limiting example embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments can, for example, achieve a stable neural network prediction for applications such as, but not limited to, object segmentation and object detection, by encoding temporal information into the input of the neural network. Using a preview of a capturing device in an electronic device, the individual frames of an input video stream may be captured and processed as a plurality of red-green-blue (RGB) images. The first frame of the input video may be input to an encoder-decoder style segmentation neural network. The neural network may analyze the first frame to identify one or more instances/objects in the first frame. The neural network may then generate predicted segmentation masks (also referred to herein as a “segmentation map”) of objects present in the first frame. A colour template, generated by a template generator (that applies at least one pre-defined colour corresponding to different object regions in the predicted segmentation masks), may be merged with the second frame of the input video to generate a temporal information encoded second frame that has temporal information of different object instances in the first frame. In this way, the temporal information can be encoded in any input frame to the neural network. The temporal information encoded second frame may then be supplied (fed) as an input to the same encoder-decoder style segmentation network to generate segmentation masks of objects present in the second frame. Another pre-defined colour-based colour template may be prepared, which corresponds to different object regions in the second input frame. This colour template may be merged with a third frame such that temporal information of the second frame is now encoded in the third frame.

The example embodiments disclosed herein may also be applicable for object detection, wherein a detection neural network analyzes a first frame for one or more instances/objects. The detection neural network may then output a bounding box prediction template for the first input frame, wherein the bounding box prediction template detects objects present in the first input frame by surrounding the objects. A coloured template of the bounding box prediction may be generated by a template generator that applies at least one predefined colour to the outputted bounding box prediction template. The bounding box coloured template for the first frame may be merged with a second input frame to encode temporal information of the first input frame into the second input frame. The second input frame, with the temporal information of the first input frame, may then be input to the detection neural network, which may then output a bounding box prediction template for objects present in the second input frame. A coloured template with the bounding box predictions for the second input frame may then be merged with a third input frame, such that the temporal information of the second input frame may now be encoded in the third input frame. The third input frame with the temporal information of the second input frame may now be fed to the detection neural network. The processes for object segmentation and object detection may occur iteratively for any subsequent frames.

It is also to be noted that the application of the example embodiments disclosed herein are not to be construed as being limited to only video instance segmentation and video object detection. The terms “video instance segmentation” and “object segmentation” may, for example, be used interchangeably to refer to the process of generating segmentation masks of objects present in an input frame. The term “modified second frame” used herein may, for example, refer to a second input frame having temporal information of a first input frame encoded into it.

By using a colour coded template for encoding past frame segmentation information or detection information, and fusion of the colour coded template with any subsequent frame, a neural network may be guided in predicting stable segmentation masks or stable bounding boxes. Examples of objects that may be segmented and detected are a person or an animal, such as, but not limited to, a cat or a dog.

The neural network may, for example, include a standard encoder-decoder architecture for object segmentation or object detection. By performing encoding at the input side, no modification may be necessary at the network side, and, due to this, it can be easily portable to electronic devices. As the colour coded template is merging with an input frame, there may not be any increase in the input size, thereby efficiently utilizing system memory and power consumption. Such advantages can, for example, enable the example embodiments disclosed herein to be suitable for real-time video object segmentation and detection.

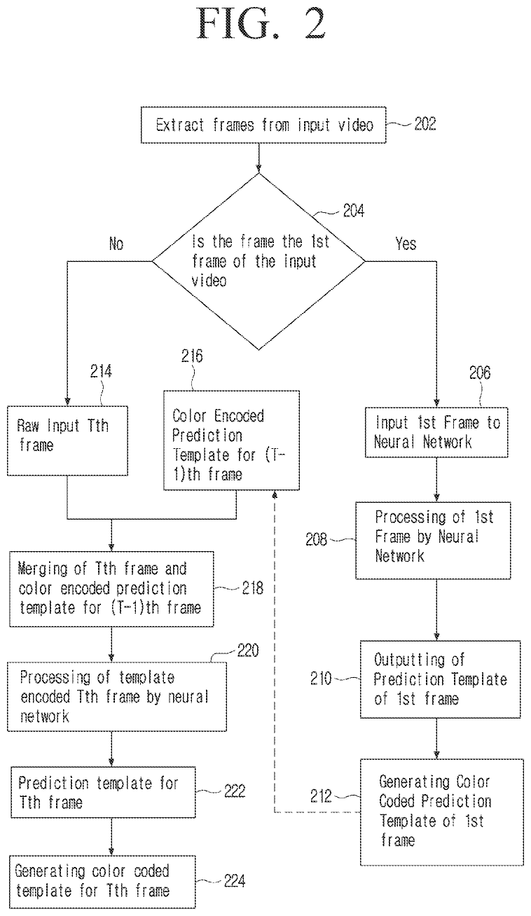

Referring now to the drawings, and more particularly to FIGS. 2 through 14, where similar reference characters denote corresponding features consistently throughout the figures, example embodiments are shown.

FIG. 2 is a flowchart for example encoding of temporal information from a previous frame onto a subsequent frame according to various embodiments.

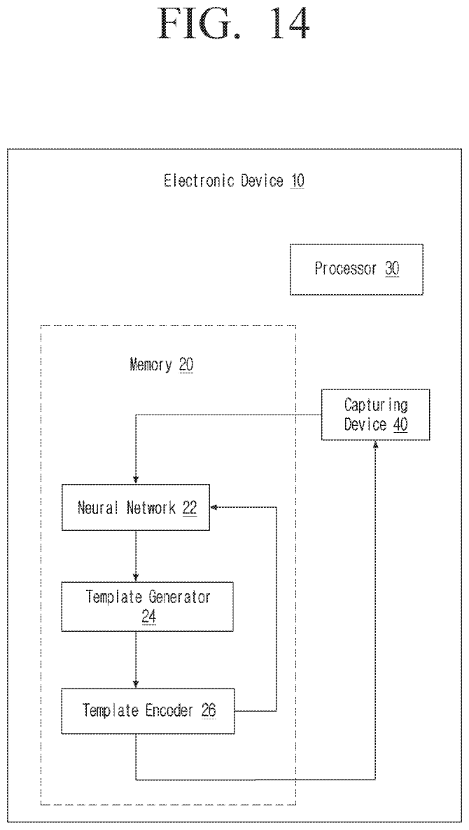

At step 202, the frames of an input video may be extracted. The frames may, for example, be extracted during a decoding of the video. The input video may be stored as a file in the memory of an electronic device (e.g., example electronic device 10 in FIG. 14) in an offline scenario. In an online scenario, the frames can be received directly from a camera image signal processor (ISP) and the extraction may be a process of reading from ISP buffers.

At step 204, it may be determined if the input frame is a first frame of the input video.

At step 206, if the input frame is the first frame of the input video, the input frame may be fed to the neural network 22 (see FIG. 14).

At step 208, the neural network may process the first frame of the input video to identify one or more instances/objects in the first frame.

At step 210, the neural network 22 may output a prediction template for the first frame having one or more instances/objects. For performing the step 208 and step 210, the neural network 22 may, for example, have an efficient backbone and a feature aggregator, that can take as an input a RGB image, and output a same sized instance map, which can be used to identify objects present in the RGB image and the location of the objects.

At step 212, the prediction template for the first frame may be fed to a template generator 24 (see FIG. 14) to generate a colour coded template of the first frame.

If, at step 204 the input frame is not the first frame of the input video, then at step 214 and step 216, a Tth frame and the colour coded prediction template for (T−1)th frame may be fed to the template encoder 26 (see FIG. 14). If the Tth frame is the second frame of the input video, then the colour coded prediction template for the first frame, which was generated at step 212, is fed to the template encoder 26 alongside the second frame.

At step 218, the template encoder 26 encodes (merges) the colour prediction template of the (T−1)th frame into the Tth frame.

At step 220, the template encoded Tth frame may be fed to the neural network 22 for processing to identify one or more instances in the template encoded Tth frame.

At step 222, the neural network 22 outputs a prediction template for the Tth frame.

At step 224, the template generator 24 may generate a colour coded template for the Tth frame.

While not illustrated in FIG. 2, the colour coded template for the Tth frame may then be input alongside the (T+1)th frame to the template encoder 26, to form a template encoded (T+1)th frame. By encoding the colour coded template of a previous frame into a subsequent frame, the temporal information of the previous frame may now be present in the subsequent frame.

The various actions in FIG. 2 may be performed in the order presented, in a different order or simultaneously. Further, in various embodiments, some actions listed in FIG. 2 may be omitted.

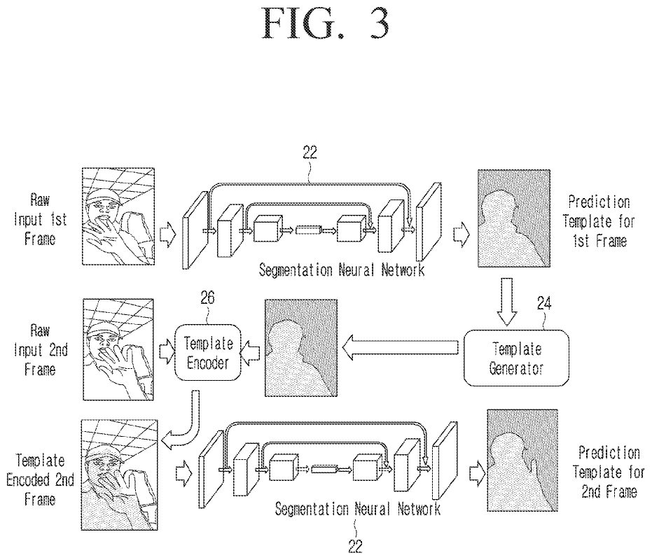

FIG. 3 illustrates an example process for encoding temporal information to perform object segmentation for a single person video sequence according to various embodiments. The first frame of the input video may be fed to a segmentation neural network 22. The segmentation neural network 22 may then output a prediction template for the first frame having segmentation masks for one or more instances/objects present in the first frame. The prediction template for the first frame may pass through a template generator 24 that outputs a colour coded template for the first frame, by applying at least one predefined colour to the segmentation masks in the prediction template for the first frame. The colour coded template for the first frame may then be input alongside the second frame of the input video to a template encoder 26. The output of the template encoder 26 may be a modified second frame, which may be the second frame which is merged with the colour coded template for the first frame such that the temporal information in the first frame is now encoded in the second frame. The modified second frame may then be fed to the segmentation neural network 22, to provide the formation of a prediction template for the second frame. While not illustrated in FIG. 3, the prediction template for the second frame may pass through the template generator 24 to obtain a colour coded template for the second frame. The colour coded template for the second frame may be input to the template encoder 26 alongside a third frame of the input video, to result in a modified third frame, which may be a template encoded third frame that includes the temporal information of the second frame.

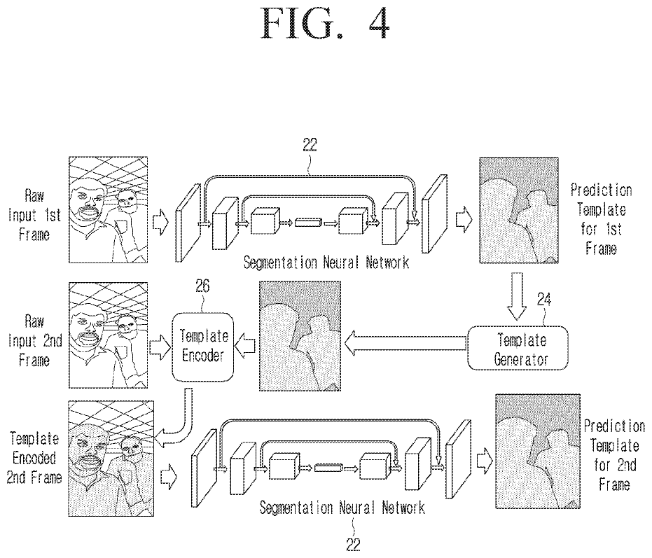

FIG. 4 is a diagram illustrating an example process for encoding temporal information to perform object segmentation for a two person video sequence according to various embodiments. The difference between the processes in FIG. 3 and FIG. 4 is that in FIG. 4, the segmentation neural network 22 outputs a prediction template for the first frame having two segmentation masks, since the input frame in FIG. 4 is for a two person video sequence. The input frame in FIG. 3 is for a single person video sequence, due to which the prediction template for the first frame may only include a single segmentation mask. For the sake of brevity, description of commonalities between FIG. 3 and FIG. 4 is not repeated.

For performing video instance segmentation, the following actions may be performed. A sequence of the frames of the input video may be extracted, which may be RGB image frames. If the present extracted frame is a first frame of the input frame sequence or of the input video, then this first frame can be considered as a temporal encoded image frame, and this frame may be fed directly as an input to the neural network.

If the present extracted frame is an intermediate frame of the input sequence, then the intermediate frame may be modified before being fed to the neural network 22. The intermediate frame may be modified by being mixed or merged with a colour coded template image to generate a temporal encoded image frame. The colour coded template image may be generated based on a previous predicted instance segmentation map. This previous predicted instance segmentation map may be output by the neural network 22 based on an input of the frame previous to the intermediate frame, to the neural network 22.

For each predicted object instance identified in the segmentation map, there may be a pre-defined colour assigned to it. The region of prediction of that object may be filled with this pre-defined colour. In an iterative manner, all the identified predicted object instances may be filled with their respective assigned pre-defined coloura to generate the colour coded template image.

Once the colour coded template image is generated, a fraction of the intermediate image frame and a fraction of the colour coded template image may be added to generate the temporal encoded image. The fraction of the intermediate image frame may, for example, be 0.9, and the fraction of the colour coded template image may be 0.1.

Once the temporal encoded image is generated, it can be fed to the neural network 22, which may predict another instance segmentation map, that may also have a pre-defined colour applied to each object instance to result in another colour coded template image for the next frame.

The above steps may be iteratively performed for all the frames of the input frame sequence or of the input video to generate a temporally stable video instance segmentation of the input frame sequence or of the input video.

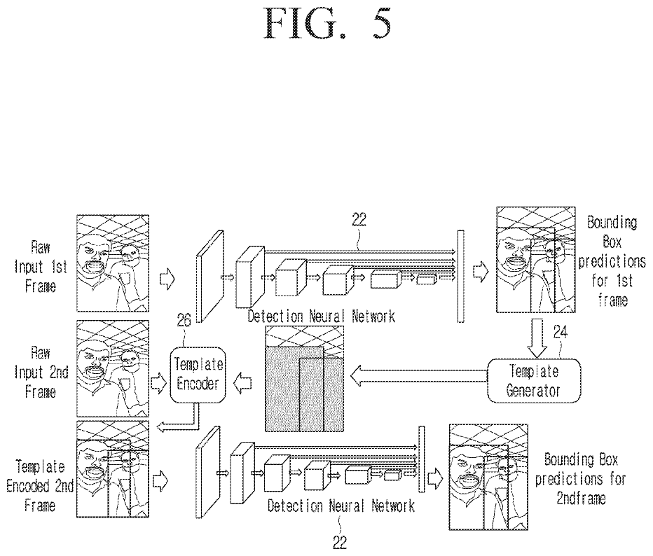

FIG. 5 illustrates an example process for encoding temporal information to perform object detection for a two person video sequence according to various embodiments. The first frame of the input video may be fed to a detection neural network 22. The output of the detection neural network 22 may, for example, be a bounding box prediction template of the first frame. The bounding box prediction template of the first frame may surround each object detected in the first frame. The bounding box prediction template of the first frame may go through a template generator 24, to form a bounding box coloured template of the first frame. The bounding box coloured template of the first frame may have at least one predefined colour applied to the bounding boxes by the template generator 24. The bounding box coloured template of the first frame, along with the second frame of the input video, may be input to the template encoder 26. The output from the template encoder 26 may be the second frame with the bounding box coloured template of the first frame encoded into it. The template encoded second frame may then be fed to the detection neural network 22, which may output a bounding box prediction for the second frame.

As neural networks 22 may be sensitive to the colour of the encoded template, a 0.1 blending fraction of the colour template (for both video instance segmentation and video object detection) to the input frame may, for example, provide better results.

The following steps may be performed for object detection. A sequence of frames of an input video may be extracted, which may be RGB image frames. If the present extracted frame is a first frame of the input video, then this frame can be considered as a temporal encoded image frame, which may be fed directly as an input to the neural network 22.

If the present extracted frame is an intermediate image frame of the input video, then the intermediate frame may be modified prior to being fed to the neural network 22. The intermediate image frame may be modified by mixing or merging with a colour coded template image, wherein the product of the mixing process can be the temporal encoded image frame.

The colour coded template image can be generated based on a predicted object detection map from the neural network 22. The colour coded template image may be initialized with zeroes. For each detected object in the predicted object detection map, a pre-defined colour may be assigned to the predicted objects. This assigned pre-defined colour may be added to the bounding region of the predicted objects in the predicted object detection map. The addition of the assigned pre-defined colour to the bounding region of each predicted object may be iteratively performed until the assigned pre-defined colour has been added to the bounding regions all of the predicted objects.

Once the colour coded template image has been generated, the values in the colour coded template may be clipped in the range 0 to 255 to restrict any overflow of the colour values. Then, a fraction of the intermediate image frame (may be added with a fraction of the colour coded template image to generate the temporal encoded image.

Once the temporal encoded image has been generated, it may be fed to the neural network 22 to predict another object detection map, which may be used to incorporate temporal information into a next frame (subsequent to the intermediate image frame) in the input video.

The above steps may, for example, be iteratively performed for all the frames in the input video to generate temporally stable video object detection of the input video.

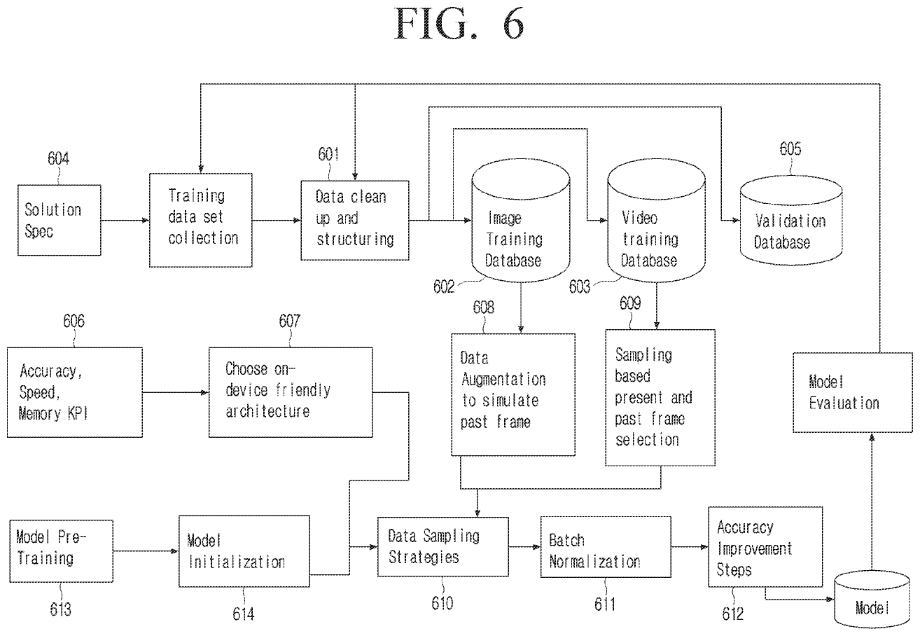

FIG. 6 illustrates a training phase for an example input model for stabilizing the neural network 22 output according to various embodiments. An input model may be evaluated for checking if the data from the model is clean. If the data from the model is not clean, then the data may be cleaned up and structured at 601. Once the data that is to be used to train the model is collected, it may be sent to an image training database 602 or a video training database 603, along with the cleaned up and structured data. Depending on whether the data corresponds to an image or a video, it will accordingly be input to the corresponding image training or video training database. The Solution Spec 604 may be used to indicate one or more key performance indicators (KPIs). The cleaned up and structured data may also be sent to a validation database 605 to train the model, evaluate it, and then validate the data from the model.

Based on KPIs 606 such as accuracy, speed, and memory of the electronic device (e.g., electronic device 10), a device-friendly architecture 607 may be chosen, which may be a combination of hardware and software. The accuracy can be measured in mean intersection over union (MIoU), where a MIoU that is greater than 92 is desirable. The current through the electronic device 10 can be as low as or less than 15 mA per frame.

The following describes the training phase of the model. The output from the image training database may undergo data augmentation to simulate a past frame (608). The output from the video training database may undergo sampling based on present and past frame selection (609). The data sampling strategies (610) may involve determining what sampling methods would be appropriate for an image or a video, based on the data received from the image training database and the video training database. The batch normalization (611) may normalize the values, relating to the sampling, to a smaller range. Eventually, steps may be taken to improve the accuracy of the training phase (612). Examples of these steps can include use of active learning strategies, variation of loss functions, different augmentations related to illumination, pose, position based stabilization in neural network 22 prediction.

The model pre-training (613), which may be an optional step, and the model initializing processes (614) may involve determining the model that is to be trained, as there may be an idea or preconception of the model that is to be trained. The choice of the device-friendly architecture may also be dependent on the model initialization process.

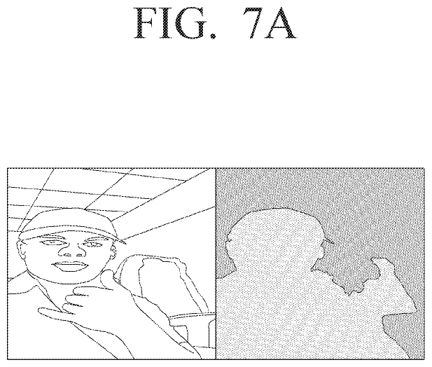

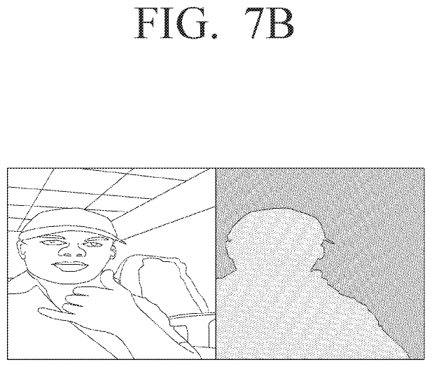

FIGS. 7A and 7B illustrate a comparison between the results from an independent frame-based segmentation and a colour template based temporal information encoded segmentation of an example video sequence. FIG. 7A illustrates that for the independent frame-based segmentation of the video sequence, in addition to the individual in the video sequence being segmented, the background objects in the video sequence are also segmented, which is an error. FIG. 7B illustrates that with colour template based temporal information encoded segmentation of the video sequence, the individual alone is segmented. It can be determined from this comparison that the use of colour template guidance in an input frame can produce highly stable results compared to when temporal information is not encoded into the input frames.

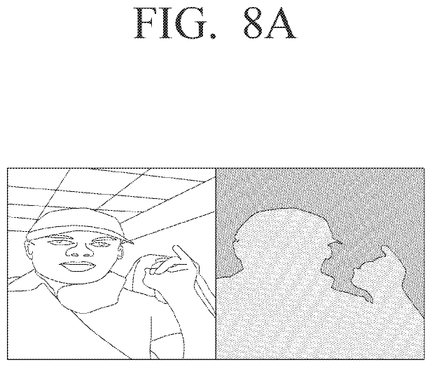

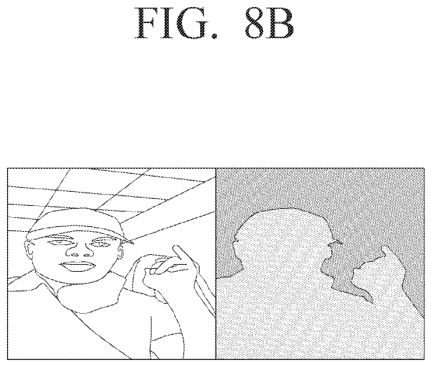

FIGS. 8A and 8B illustrate a comparison between the results from a fourth channel with grayscale segmentation map used for temporal information encoding and a colour template used for temporal information encoding. In both results, the segmentation of the individual in the video sequence is correctly performed. However, since colour template based encoding can be implicitly done, compared to the addition of a separate fourth channel to the input of a neural network 22, the neural network 22 may have a better capability to auto-correct, which can restrict propagation of errors in the subsequent frames.

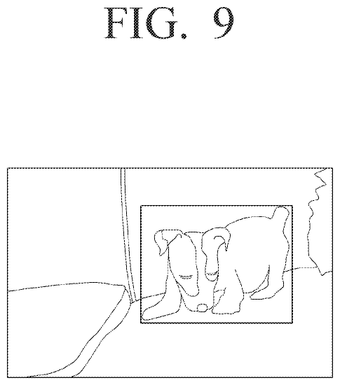

FIG. 9 is an example screenshot of object detection performed using temporal information encoding according to various embodiments. The object in the video sequence is a dog, which is correctly detected based on the bounding box surrounding the dog.

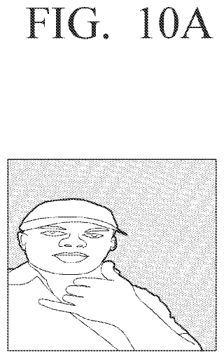

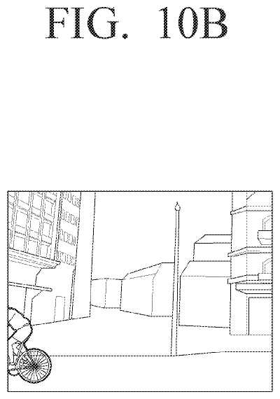

FIGS. 10A and 10B are example screenshots of video instance segmentation performed using temporal information encoding according to various embodiments. FIG. 10A illustrates a video instance segmentation using front camera portrait segmentation. FIG. 10B illustrates a video instance segmentation using rear camera action segmentation.

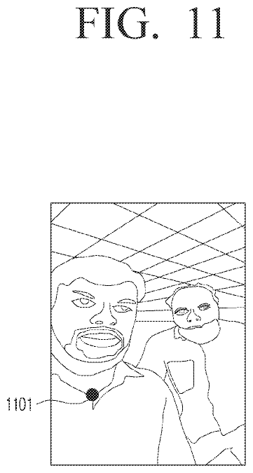

FIG. 11 is an example screenshot of selective instance segmentation performed using temporal information encoding according to various embodiments. Based on a user touch (as indicated by the black dot 1101), a corresponding person based studio mode may be activated. The temporal information encoding methods disclosed herein may, for example, stabilize the predictions by maintaining high quality temporal accuracy for selective instance segmentation use.

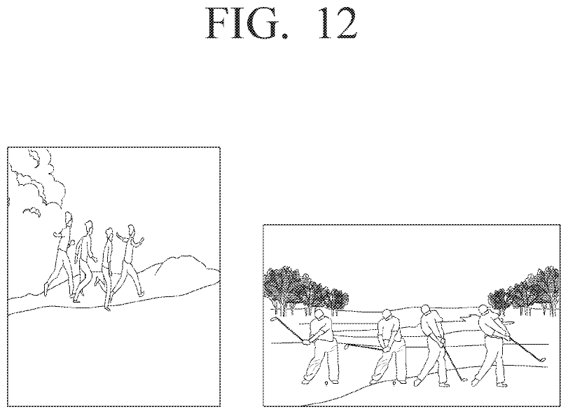

FIG. 12 are example screenshots of creating a motion trail effect using temporal information encoding according to various embodiments. The user may record a video with a static background where there may only be a single moving instance, which may be segmented across all the frames, and later composed to generate a motion trail.

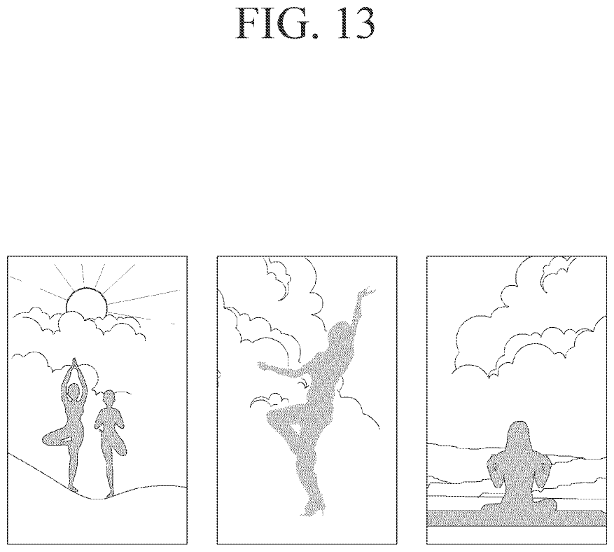

FIG. 13 are example screenshots of adding filters to instances segmented using temporal information encoding according to various embodiments. When a user records a video, all the instances may be segmented in the video across all frames. The instance masks may then be processed and composed with a predefined background.

FIG. 14 illustrates an example electronic device 10 that is configured to encode temporal information into any subsequent frames for stable neural network prediction according to various embodiments. The electronic device 10 may be a user device such as, but not limited to, a mobile phone, a smartphone, a tablet, a laptop, a desktop computer, a wearable device, or any other device that is capable of capturing data such as an image or a video. The electronic device 10 may include a memory 20, a processor 30, and a capturing device 40.

The capturing device 40 (including, e.g., a camera) may capture a still image or moving images (an input video). An example of the capturing device 40 can be a camera.

The memory 20 may store various data such as, but not limited to, the still image and the frames of an input video captured by the capturing device. The memory 20 may store a set of instructions, that when executed by the processor 30, cause the electronic device 10 to, for example, perform the actions outlined in FIGS. 2, 3, 4, and 5. Examples of the memory 20 can be a flash memory type storage medium, a hard disk type storage medium, a multi-media card micro type storage medium, a card type memory (for example, an SD or an XD memory), random-access memory (RAM), static RAM (SRAM), read-only memory (ROM), electrically erasable programmable ROM (EEPROM), programmable ROM (PROM), a magnetic memory, a magnetic disk, or an optical disk.

The processor 30 (including, e.g., processing circuitry) may be, but is not limited to, a general purpose processor, a digital signal processor, an application specific integrated circuit (ASIC), and a field programmable gate array (FPGA).

The neural network 22 may receive from the capturing device 40 an input such as the frames of a video. The neural network 22 may process the input from the capturing device to output a prediction template. Depending on the task to be performed, the prediction template may have a bounding box prediction or a colour coded prediction over the objects in the prediction template. When the prediction template passes through a template generator 24, the template generator 24 may output a template in which the objects in the prediction template are colour coded or surrounded by a bounding box. The output from the template generator 24 may be encoded with the subsequent frame of the input video, received from the capturing device, with the help of a template encoder 26. The output from the template encoder 26 may then be input to the neural network 22 for further processing.

The example embodiments disclosed herein describe systems and methods for encoding temporal information. It will be understood that the scope of the protection is extended to such a program and in addition to a computer readable medium having a message therein, such computer readable storage medium including program code for implementation of one or more steps of the method, when the program runs on a server or mobile device or any suitable programmable device. The method may, for example, be implemented in at least one embodiment through or together with a software program written in, for example, very high speed integrated circuit Hardware Description Language (VHDL) or another programming language, or implemented by one or more VHDL or several software modules being executed on at least one hardware device. The hardware device can be any kind of device (e.g., a portable device) that can be programmed. The device may include hardware such as an ASIC, or a combination of hardware and software, such as an ASIC and an FPGA, or at least one microprocessor and at least one memory with software modules located therein. The method embodiments described herein may be implemented partly in hardware and partly in software. Alternatively, the example embodiments may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

While the disclosure has been illustrated and described with reference to various example embodiments, it will be understood that the various embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for encoding temporal information in an electronic device, the method comprising:
identifying, by a neural network, at least one region indicative of one or more instances in a first frame by analyzing a first frame among a plurality of frames;
outputting, by the neural network, a prediction template including the one or more instances in the first frame;
generating, by a template generator, a colour coded template of the first frame by applying at least one colour to the prediction template having the one or more instances in the first frame; and
generating, by a template encoder, a modified second frame by combining a second frame among the plurality of frames and the colour coded template of the first frame.

2. The method of claim 1, further comprising:
supplying the modified second frame to the neural network;
identifying, by the neural network, at least one region indicative of one or more instances in the modified second frame by analyzing the modified second frame;
outputting, by the neural network, a prediction template having the one or more instances in the modified second frame;
generating, by the template generator, a colour coded template of the modified second frame by applying at least one colour to the prediction template having the one or more instances in the modified second frame;
generating, by the template encoder, a modified third frame, by combining a third frame and the colour coded template of the modified second frame; and
supplying the modified third frame to the neural network.

3. The method of claim 1, wherein the plurality of frames is from a preview of a capturing device, and wherein the plurality of frames is represented by a red-green-blue (RGB) colour model.

4. The method of claim 1, wherein the combination of the second frame and the colour coded template of the first frame has a blending fraction value of 0.1.

5. The method of claim 1, wherein the neural network is one of a segmentation neural network or an object detection neural network.

6. The method of claim 5, wherein the output of the segmentation neural network includes one or more segmentation masks of the one or more instances in the first frame.

7. The method of claim 5, wherein the output of the object detection neural network includes one or more bounding boxes of the one or more instances in the first frame.

8. The method of claim 1, wherein the electronic device includes a smartphone or a wearable device that is equipped with a camera.

9. The method of claim 1, wherein the neural network is configured to receive the first frame prior to analyzing the first frame.

10. An intelligent instance segmentation method in a device, the method comprising:
receiving, by a neural network, a first frame from among a plurality of frames;
analyzing, by the neural network, the first frame to identify a region indicative of one or more instances in the first frame;
generating, by the neural network, a template having the one or more instances in the first frame;
applying, by a template generator, at least one colour to the template having the one or more instances in the first frame to generate a colour coded template of the first frame;
receiving, by the neural network, a second frame;
generating, by a template encoder, a modified second frame by merging the colour coded template of the first frame with the second frame; and
fsupplying the modified second frame to the neural network to segment the one or more instances in the modified second frame.

11. An image segmentation method in a camera device, the method comprising:
receiving, by a neural network, an image frame including red-green-blue channels;
generating, by a template generator, a template including one or more colour coded instances from the image frame; and
merging, by a template encoder, a template including the one or more colour coded instances with the red-green-blue channels of image frames subsequent to the image frame as a preprocessed input for image segmentation in the neural network.

12. A system for encoding temporal information, comprising:
a capturing device including a camera;
a neural network, wherein the neural network is configured to:
identify at least one region indicative of one more instances in a first frame by analyzing the first frame among a plurality of frames from a preview of the capturing device, and
output a prediction template having the one or more instances in the first frame, and
a template generator configured to generate a colour coded template of the first frame by applying at least one colour to the prediction template having the one or more instances in the first frame; and
a template encoder configured to generate a modified second frame by merging a second frame and the colour coded template of the first frame.

13. The system of claim 12, wherein the neural network is configured to receive the first frame and the modified second frame.

14. The system of claim 12, wherein the plurality of frames from the preview of the capturing device is represented by a red-green-blue (RGB) colour model.

15. The system of claim 12, wherein the merging of the second frame and the colour coded template of the first frame has a blending fraction value of 0.1.
